(19) United States
(12) Patent Application Publication
(10) Pub. No.: US 2026/0237038 A1
(43) Pub. Date: Aug. 13, 2026

(54) SYSTEM AND METHOD FOR IDENTIFYING AND CLASSIFYING DETERIORATION IN AN OBJECT USING ARTIFICIAL INTELLIGENCE

(71) Applicant: USA AS REPRESENTED BY THE SEC OF THE NAVY, San Diego, CA (US)

(72) Inventors: Sara Wheeland, San Diego, CA (US); Shibin Parameswaran, San Diego, CA (US); Ivan Febus-Rivera, San Diego, CA (US)

(73) Assignee: USA AS REPRESENTED BY THE SEC OF THE NAVY, San Diego, CA (US)

(21) Appl. No.: 19/049,144

(22) Filed: Feb. 10, 2025

(51) Int. Cl. G06T 7/00; G06T 7/13

(52) U.S. Cl. CPC G06T 7/0002; G06T 7/13; G06T 2207/10032; G06T 2207/30168

(57) ABSTRACT

The multiple embodiments of the present invention include a system and method for detecting deterioration in an object by capturing images of the object with an unmanned aerial vehicle and using artificial intelligence to analyze the images.

### FEDERALLY-SPONSORED RESEARCH AND DEVELOPMENT

The United States Government has ownership rights in the invention claimed herein. Licensing and technical inquiries may be directed to the Office of Research and Technical Applications, Naval Information Warfare Center Pacific, Code 72120, San Diego, CA, 92152; voice (619) 553-5118; NIWC_Pacific_T2@us.navy.mil. Reference Navy Case Number 211844.

### BACKGROUND OF THE INVENTION

Accessibility to equipment or structures provides opportunities for maintenance and repair. Where accessibility is low due to such things as being underwater, underground, at some height or due to surrounding difficult terrain, different methodologies may be used to inspect for the need for such maintenance or repairs. Detecting deterioration in an object can be a goal in an inspection.

### SUMMARY

In an embodiment, the invention relates to a system for detecting deterioration comprising an unmanned aerial vehicle, an image capture device coupled to the unmanned aerial vehicle for capturing images of an object and a deterioration detection module for determining the presence of deterioration.

In an embodiment, a method for detecting deterioration in an object comprises flying an unmanned aerial vehicle in proximity to an object, capturing an image of the object with an image capture device coupled to the unmanned aerial vehicle and detecting deterioration in the object by comparing at least a portion of the captured image with a predetermined image pattern of deterioration for that object.

### BRIEF DESCRIPTION OF THE DRAWINGS

Throughout the several views, like elements are referenced using like references. The elements in the FIG.s may not be drawn to scale and some dimensions may be exaggerated for clarity.

FIG. 1 is a diagram illustrating an environment in which a portion of a system for detecting deterioration operates, according to one or more embodiments of the present disclosure.

FIG. 2 is a functional block diagram illustrating a system for detecting deterioration according to one or more embodiments of the present disclosure.

FIG. 3 is a diagram illustrating a computer component including a deterioration detection module according to one or more embodiments of the present disclosure.

FIG. 4 is an image containing a heat map, according to one or more embodiments of the present disclosure.

FIG. 5A is an image showing a top view of an object with a heat map of deterioration according to one or more embodiments of the present disclosure.

FIG. 5B is a rotated image of the image shown in FIG. 5A, according to one or more embodiments of the present disclosure.

FIG. 6 is a figure illustrating a view of an object that has a permutation, according to one or more embodiments of the present disclosure.

FIG. 7 is a flowchart of a method for detecting deterioration in an object according to one or more embodiments of the present disclosure.

### DETAILED DESCRIPTION OF EMBODIMENTS

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically. Additionally, the terminology used herein is for the purpose of description and not of limitation. Furthermore, although certain methods are described with reference to steps that are presented herein in a certain order, in many instances, these steps may be performed in any order as may be appreciated by one skilled in the art; the novel method is therefore not limited to the particular arrangement of steps disclosed herein.

It must be noted that as used herein and in the appended claims, the singular forms “a”, “an”, and “the” include plural references unless the context clearly dictates otherwise. Furthermore, the terms “a” (or “an”), “one or more” and “at least one” can be used interchangeably herein. The terms “comprising”, “including”, “having” and “constructed from” can also be used interchangeably.

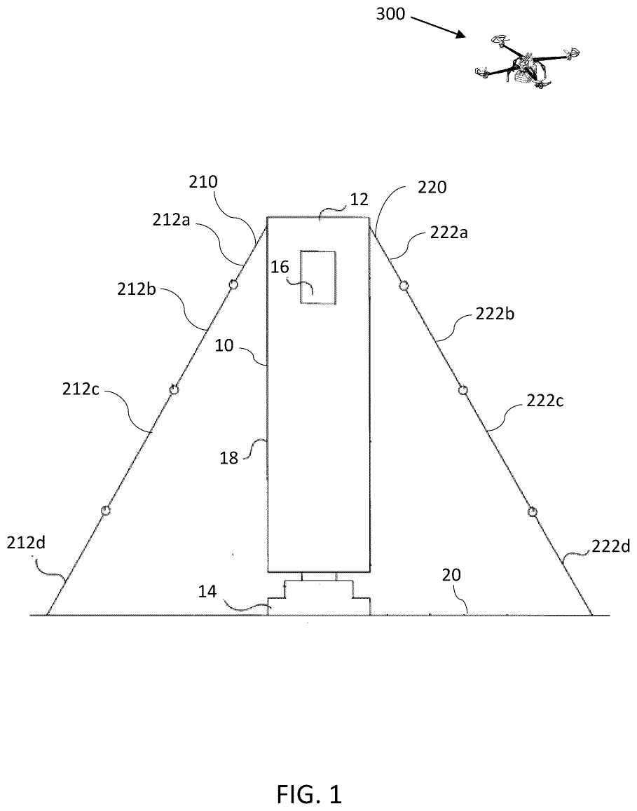

Referring to FIG. 1, an environment for at least a portion of which a system 100 for detecting deterioration operates within is shown. A tower 10 has an object such as guy wires 210, 220 for which it is desirous to determine if deterioration is present. The guy wires 210, 220 extend from the top 12 of the tower 10 to the ground 20 and each guy wire 210, 220 has multiple segments 212a, 212b, 212c, 212d and 222a, 222b, 222c, 222d, respectively. The tower 10 further includes a base 14 on which the body 18 of the tower sits upon. A logo 16 is located on-the surface of the tower. An unmanned aerial vehicle (UAV) 300 is flying in proximity to the guy wires 210, 220. Examples of proximity include flying within one hundred feet and in an embodiment, proximity is flying within twenty feet or less.

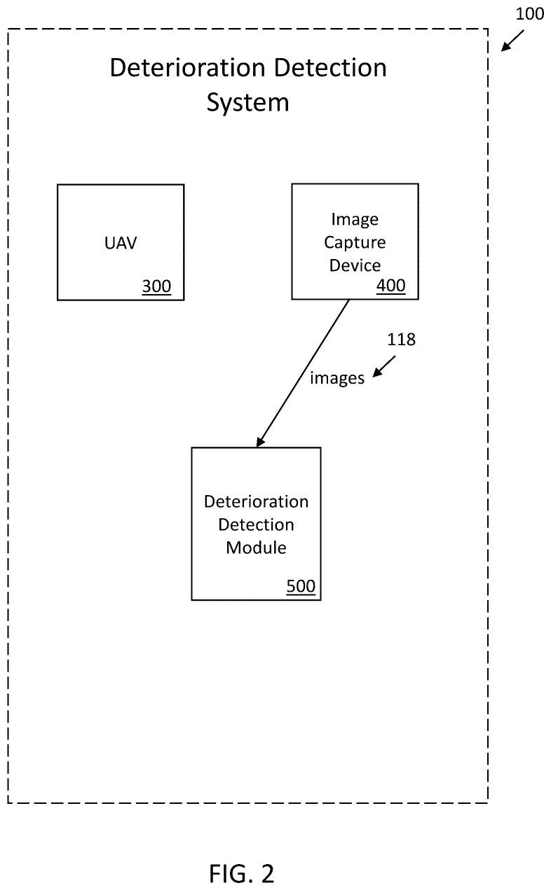

Referring to FIG. 2, a functional block diagram of a system 100 for detecting deterioration is shown. The system for detecting corrosion comprises a UAV 300, an image capture device 400 that is adapted to capture images of an object, and a deterioration detection module 500. The UAV may be any type of flying vehicle in which the operator does not fly with the vehicle. In an embodiment, the UAV 300 is quadcopter capable of vertical lift, hovering and of transporting the image capture device 400. The image capture device is capable of capturing a single digital image or is a video camera. The image capture device can include a sensor that can capture electromagnetic radiation including visible light, non-visible light such as infrared, radio waves and x-rays. The image capture device has a resolution at a minimum of 480p. In an embodiment, a resolution of 720p or more is used. In yet another embodiment has a resolution of 4k, and in a further embodiment has a resolution of 8k. In an embodiment, ultrasound may be used and may include a medium such as water to conduct sound against the object. In this embodiment, a sound sensor on the UAV may be used.

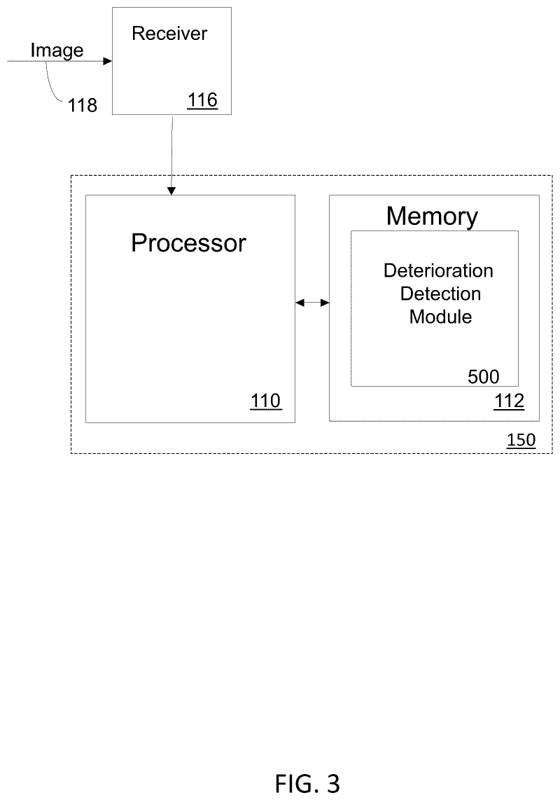

The deterioration detection module 500 may be adapted to determine deterioration in an object, for example, corrosion in metal guy wires 210, 220 such as those shown attached to the tower 10 shown in FIG. 1. Referring to FIG. 3, in an embodiment a deterioration detection module 500 may be a computer component 150 or part of a computer component, implemented in hardware or software. The deterioration detection module 500 may stored within a memory 112 and receives an image 118 through a receiver 116. Determinations that include identification, convolutional neural network (CNN) operational steps, image rotation, locating, etc are processed using a computer processor 110 that interacts with memory 112 and runs algorithms that form part of the deterioration detection module 500. In an embodiment, the deterioration detection module 500 may be located on the UAV or in another embodiment is located at a remote location from the UAV, where the remote location has the capability to receive images 118 from the image capture device 400.

In an embodiment, edge detection pattern recognition is used by the deterioration detection module 500 to determine if deterioration is indicated in the captured image. Edge detection highlights areas in an image where there is a predetermined change in intensity that is representative of what is desired to be measured. In an embodiment, edge detection pattern recognition is used to determine the edges of deterioration on an object surface where the change in intensity contrasts deterioration as compare to a portion of an object surface that is not of sufficient intensity contrast to categorize as deterioration. Edge detection maybe used to define the outer perimeter of the deterioration.

In an embodiment, the deterioration detection module 500 separates an image into at least a category of object and a category of non-object. The deterioration detection module 500 analyzes an image that has certain level of granularity or pixelation. The image as a whole is comprised of a number of sub units or pixels. Each pixel will be determined to be either representative of the object or of a non-object. Example of non-objects include background, other objects for which deterioration determination is not desired or other miscellaneous elements that appear in the image that are not the object of concern. In an embodiment, the deterioration detection module 500 identifies elements of the image as outliers. The deterioration detection module 500 iteratively selects random subsets of image pixels to develop a model, for example a color or intensity threshold, that includes the majority of inlier points while also identifying outliers. One example of an outlier identification process includes random sample consensus (RANSAC).

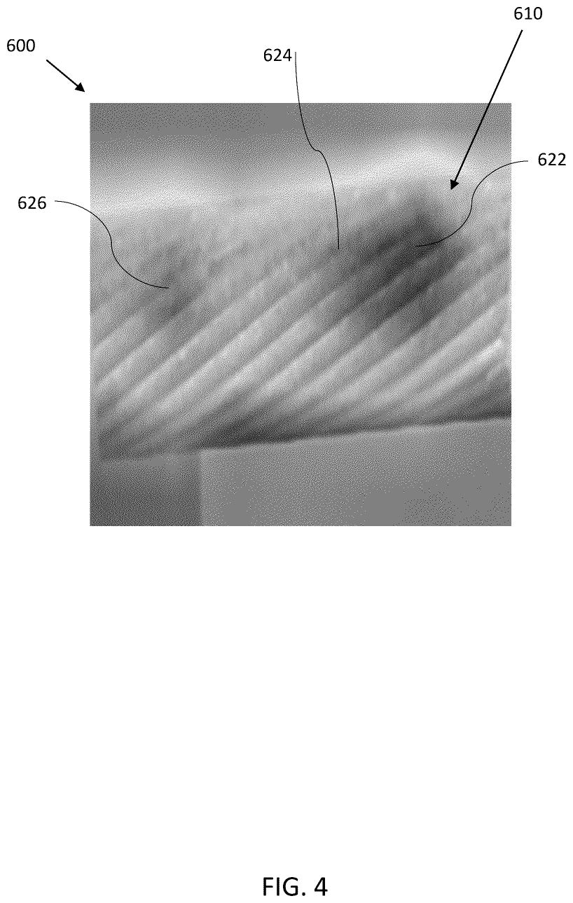

Referring to FIG. 4, in an embodiment, the deterioration detection module produces a heat map 600 that visually indicates a plurality of deterioration levels in an image. In an embodiment, two or more levels of deterioration is indicated, for example, in a metal guy wire 610, three levels of corrosion, high 622, medium 624 and low 626 are determined. Edge detection pattern recognition to produce a heat map. Multiple heat maps may be created to represent the deterioration in an object, for example, where each heat map covers unique locations on the object where deterioration is present. A number of ways may be used to visually differentiate between levels of deterioration where the spectrum can be represented through for example, intensity and color.

In an embodiment, the deterioration detection module determines the orientation of the object. It is desirable to capture an image of an object that has an orientation that matches pre-existing images that represent the presence of such deterioration. Artificial intelligence algorithms that perform deep learning for pattern matching can have their performance improved if a captured image is first aligned with an image contained in an image library before the pattern matching occurs. Thus, in an embodiment, the deterioration detection module rotates the image of the object before determining a level of deterioration to match the orientation of an image in an image library. The UAV which captures the images of the object can have its flight path optimized if image rotation is used because the UAV will not have to fly certain paths to capture an aligned image, relying instead to have image processing align the image instead.

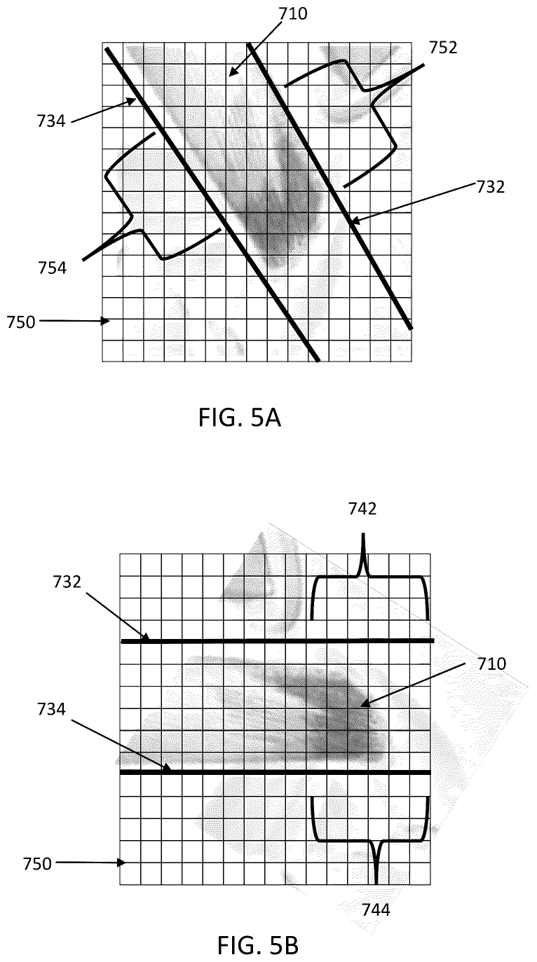

Referring to FIG. 5A, a top view of a guy wire 710 is shown. In the image, the guy wire 710 extends in a direction that is about sixty degrees from horizontal. The degree the guy wire is off horizontal can be determined by fitting one or more lines 732, 734 onto the guy wire that aligns with the direction in which the guy wire extends. The guy wire 710 is shaped generally as a cylinder. The lines 732, 734 may be fitted onto the edges of the guy wire 710 or the centerline or some other line that represents the direction to which such a cylindrically-shaped object extends. A grid 750 representing pixels is overlaid on the image. Line 732, 734 each segment a number of pixels 752, 754, respectively, as the lines do not align with the edges of the square shaped pixels.

Referring to FIG. 5B, the image of the guy wire 710 has been rotated such that lines 732, 734 are horizontal and align with the edges of pixels 742 and 744, respectively. In this form, the performance of the pattern matching is improved as the captured image of the guy wire 710 is aligned with images of guy wires contained in an image library used for training. While, in this embodiment, lines that align with linear features of an object were used to rotate the image of an object to improve pattern matching, curves, shapes and other features may be used to align a captured image of an object to a pre-existing image of a corresponding object contained in an image library. The pre-existing image may be used directly or a module such as the Deterioration Detection module 500 that used the pre-existing image for training only.

In an embodiment, the deterioration detection module uses a CNN to classify a level of deterioration for a portion of the object. A CNN learns to recognize complex patterns in images by progressively building up understanding from features contained in multiple images. Thus multiple images of an object having differing levels of deterioration are used with the CNN to train the pattern recognition used by the Deterioration Detection Module 500. Multiple of images of the same level of deterioration but taken at different angles, for example zero to 180 degree, at different distances, and at different radial positions may also be used to train the Deterioration Detection Module 500.

In an embodiment, the deterioration detection module determines the location of at least a portion of the object relative to other portions of the object. The UAV flies a flight path to capture all areas of concern to determine if there is deterioration present with the object. Images which capture a portion of the object are spatially located along the length, area and/or faces of an object such that in combination, all of the images captured include all of the predetermined or desired portions of the object. To accomplish this goal, a sequence of captured images are processed to determine what area of the object is desired to be captured, what has already been captured and the location of the already captured images recorded. As each captured location is recorded an evaluation is done to determine what images have not yet been captured. In an example, if an object is cube in shape, it is desired to capture images of its top, bottom, front face, back face and two sides. If images have been captures of the top, bottom, front face and back face, these already captured images are recorded and the need to further capture images of the two sides are indicated.

In a further example, referring to FIG. 1, the guy wires 210, 220 are the objects where deterioration is to be determined. The guy wires 210, 220 extend from the top of the tower 12 to the ground 20. Each of guy wires 210, 220 can be divided into segments 212a, 212b, 212c, 212d and 222a, 222b, 222c, 222d, respectively. As the UAV 300 captures images, the flight path of the UAV 300 will follow a path to insure it will capture images of each of segments 212a, 212b, 212c, 212d and 222a, 222b, 222c, 222d. Moreover, for each of segments 212a, 212b, 212c, 212d and 222a, 222b, 222c, 222d, the UAV 300 will fly a path that will capture a desired portion of the cylindrically-shaped surfaces. In an embodiment, the UAV 300 flies in a path that revolves in whole or in part around the centerline of one or more of the segments that would allow for a complete 360 degree image capture of a segment of the guy wires 210, 220. A 360 degree image capture can be accomplished in a number of azimuths including those that align with movement directly aligned with a length, width or circumference of an object and may include azimuths located there between or at an angle to.

In an embodiment, image recognition of the object or of a background is used in an automated process to guide the UAV 300 along a flight path for capturing a series of individually unique images of the object. The automated process includes a flight path that is comprehensive in directing the UAV 300 such that the desired images are captured. Examples of object features that may be used for guiding the UAV may be a known area of a side or length of a portion of the object. Referring to FIG. 1, examples of background objects that may be used for guiding the UAV include the tower 10, the tower base 14 and the logo 16, where features related to such background such as their known height, width, or a scale chart is used by the UAV to determine its distance and relative location from the background object or to other objects. In an embodiment, referring to FIG. 1, the diameter of the guy wires 210, 220 is a known value from which the UAV 300 can estimate distance to the guy wires 210, 220, tower 10 and the ground 20 using the image capture device 400. In an embodiment, the UAV is able to determine its relative location to each of the segments 212a, 212b, 212c, 212d and 222a, 222b, 222c, 222d using the distance values derived from image recognition. The UAV 300 may include other navigational devices such as global positioning system, a gyroscope, and/or a speed measuring device that work alone or combination with the image capture device 400 to determine the speed, altitude, distance and location of the UAV.

In an embodiment, the deterioration detection module is able to determine the presence of non-visible deterioration from an image using swelling analysis. Non-visible deterioration may include difficult or hard to determine deterioration because color differentiation or other features such as a raised surface may not have an acceptable image difference level for image processing to identify. For example, when capturing images from a normal direction extending outward from the surface of the object, edge detection is unable to identify a difference in color or intensity. Swelling analysis may be used to improve the detection of deterioration. In an embodiment, a higher resolution image capture device is used for example, upgrading to 4k from 1080 and in another example, upgrading from 4k to 8k.

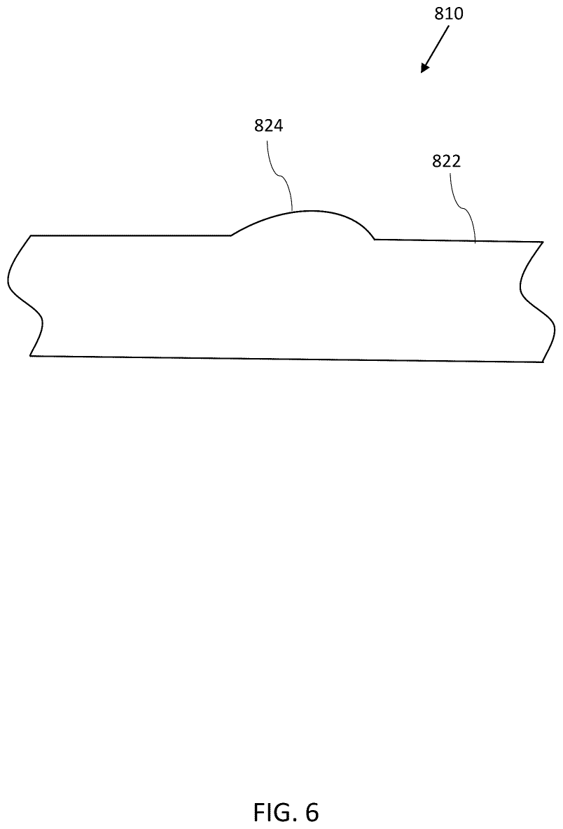

In an embodiment, swelling analysis comprises analyzing visual data to determine height permutations of a surface of the object using a view that is parallel to the surface of the object and is orthogonal to the direction the permutation extends. As shown in FIG. 6, a permutation 824 is shown raised above the surface 822 of the object 810. The angle of the image in FIG. 6 is parallel to within ten degrees of parallel to the surface 822 of the object 810 where swelling is to be detected, and in an embodiment, is within five degree of parallel.

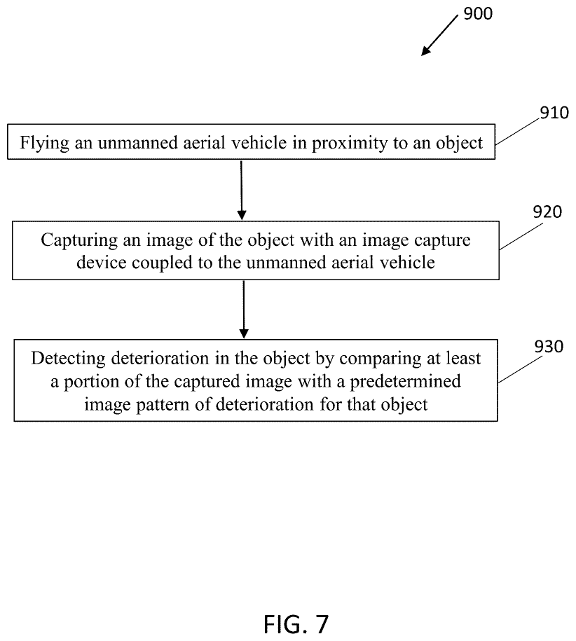

FIG. 7 is a flowchart 900 illustrating a method for detecting deterioration in an object that comprises flying an unmanned aerial vehicle in proximity to an object 910, capturing an image of the object with an image capture device coupled to the unmanned aerial vehicle 920 and detecting deterioration in the object by comparing at least a portion of the captured image with a predetermined image pattern of deterioration for that object 930. In an embodiment, the method, where in the step of detecting deterioration in the object, includes using edge detection pattern recognition. In an embodiment, the method of where in the step of detecting deterioration in the object, includes using a Convolutional Neural Network to classify a level of deterioration for a portion of the object.

In an embodiment, the method, where in the step of detecting deterioration in the object, comprises determining an orientation of the object and drawing at least one line segment across a pixel of the image that corresponds to a feature of the object. A feature may include an edge, a shape, a curve, and a centerline. In an embodiment, the method, where in the step of detecting deterioration in the object, comprises utilizing swelling analysis that analyzes visual data to determine height permutations of a surface of the object using a view orthogonal to the direction the permutation extends. In an embodiment, the method, in the step of flying an unmanned aerial vehicle in proximity to an object, comprises using a background of a captured image in an automated process to guide the unmanned aerial vehicle along a flight path for capturing a series of individually unique images of the object. In an embodiment, the method, where in the step of flying an unmanned aerial vehicle in proximity to an object, a background of a captured image is used to locate the unmanned aerial vehicle within a reference system.

Computer storage media and/or memory includes volatile and non-volatile, removable and non-removable media and memory implemented in any method or technology for storage of information such as computer readable instructions, data structures, program modules, distributed networks, cloud-computing or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a mobile device, computer, server, and so forth. For example, instructions embodying an application or program are included in one or more computer-readable storage media, such as tangible media, that store the instructions in a non-transitory manner.

Various techniques are described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media.”

Certain attributes, functions, steps of methods, or sub-steps of methods described herein are associate with physical structures or components, such as a module of a physical device, that in implementations in accordance with this disclosure make use of instructions (e.g., computer executable instructions) that are embodied in hardware, such as an application specific integrated circuit, computer-readable instructions that cause a computer (e.g., a general-purpose computer) executing the instructions to have defined characteristics, a combination of hardware and software such as processor implementing firmware, software, and so forth such as to function as a special purpose computer with the ascribed characteristics.

For example, in embodiments a module comprises a functional hardware unit (such as a self-contained hardware or software or a combination thereof) designed to interface the other components of a system. In embodiments, a module is structured to perform a function or set of functions, such as in accordance with a described algorithm. That this disclosure implements nomenclature that associates a particular component or module with a function, purpose, step or sub-step is used to identify the structure, which in instances includes hardware and/or software that function for a specific purpose. The structure corresponding to the recited function being understood to be the structure corresponding to that function and the equivalents thereof permitted to the fullest extent of this written description, which includes the accompanying claims and the drawings as interpreted by one of skill in the art.

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about”, “generally” and “approximately” as used herein mean a reasonable amount of deviation of the modified term such that the end result is not significantly changed.

From the above description, it is manifest that various techniques may be used for implementing the concepts without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that the systems and methods are not limited to the particular embodiments described herein, but is capable of many embodiments without departing from the scope of the claims.

I/We claim:

1. A system for detecting deterioration comprising:
an unmanned aerial vehicle;
an image capture device coupled to the unmanned aerial vehicle for capturing images of an object;
a deterioration detection module for determining the presence of deterioration.

2. The system of claim 1 where edge detection pattern recognition is used to determine if deterioration is indicated in the captured image.

3. The system of claim 1 where the deterioration detection module separates an image into at least a category of object and a category of non-object.

4. The system of claim 1 where the deterioration detection module identifies elements of the image as outliers.

5. The system of claim 1 where the deterioration detection module determines the orientation of the object.

6. The system of claim 1 where the deterioration detection module determines the location of at least a portion of the object relative to other portions of the object.

7. The system of claim 1 where the deterioration detection module rotates the image of the object before determining a level of deterioration.

8. The system of claim 1 where the deterioration detection module uses a Convolutional Neural Network to classify a level of deterioration for a portion of the object.

9. The system of claim 1 where the deterioration detection module produces a heat map that visually indicates a plurality of deterioration levels in an image.

10. The system of claim 1 where image recognition of the object or of a background is used in an automated process to guide the unmanned aerial vehicle along a flight path for capturing a series of individually unique images of the object.

11. The system of claim 1 where image recognition of an object or background is used to locate the unmanned aerial vehicle within a reference system.

12. The system of claim 1 where non-visible corrosion is determined from an image using swelling analysis.

13. The system of claim 12 where swelling analysis comprises analyzing visual data to determine height permutations of a surface of the object using a view that is orthogonal to the direction to which the object extends and is orthogonal to the direction the permutation extends.

14. A method for detecting deterioration in an object comprising
flying an unmanned aerial vehicle in proximity to an object;
capturing an image of the object with an image capture device coupled to the unmanned aerial vehicle; and
detecting deterioration in the object by comparing at least a portion of the captured image with a predetermined image pattern of deterioration for that object.

15. The method of claim 14 where in the step of detecting deterioration in the object includes using edge detection pattern recognition.

16. The method of claim 14 where in the step of detecting deterioration in the object includes using a Convolutional Neural Network to classify a level of deterioration for a portion of the object.

17. The method of claim 14 where in the step of detecting deterioration in the object comprises determining an orientation of the object and drawing at least one line segment across a pixel of the image that corresponds to a feature of the object.

18. The method of claim 14 where in the step of detecting deterioration in the object comprises utilizing swelling analysis that analyzes visual data to determine height permutations of a surface of the object using a view orthogonal to the direction the permutation extends.

19. The method of claim 14 where in the step of flying an unmanned aerial vehicle in proximity to an object comprises using a background of a captured image in an automated process to guide the unmanned aerial vehicle along a flight path for capturing a series of individually unique images of the object.

20. The method of claim 19 where in the step of flying an unmanned aerial vehicle in proximity to an object a background of a captured image is used to locate the unmanned aerial vehicle within a reference system.
